(19) United States
(12) Patent Application Publication
(10) Pub. No.: US 2015/0032359 A1
(43) Pub. Date: Jan. 29, 2015

(54) METHOD OF CORRECTING OPERATING SET POINTS OF AN INTERNAL COMBUSTION ENGINE

(71) Applicant: GM GLOBAL TECHNOLOGY OPERATIONS LLC, Detroit, MI (US)

(72) Inventor: Serena TORDIN, Settimo Torinese (DE)

(21) Appl. No.: 14/446,090

(22) Filed: Jul. 29, 2014

(30) Foreign Application Priority Data
Jul. 29, 2013 (GB) 1313485.3

(51) Int. Cl. F02D 41/18; F02D 41/34

(52) U.S. Cl. CPC F02D 41/182; F02D 41/34
USPC 701/104

(57) ABSTRACT

A method of correcting operating set points of an internal combustion engine is disclosed. The method includes predetermining an oxygen sensor time correction factor representative of a delay between a combustion event of a fuel quantity injected into a cylinder of the engine and a measurement in the exhaust pipe of an air-to-fuel ratio produced by said combustion event; calculating a fuel injection error quantity as a difference between a nominal fuel quantity and an estimated fuel quantity injected into the cylinder, the nominal fuel quantity being determined for an injection that precedes the measurement of an air-to-fuel ratio value by the oxygen sensor time correction factor, the estimated fuel quantity being determined as a function of an air mass flow value and of the measured air-to-fuel ratio value; and correcting the operating set points of the internal combustion engine using the calculated fuel injection error quantity.

### CROSS REFERENCE TO RELATED APPLICATION

This application claims priority to GB Patent Application No. 1313485.3 filed Jul. 29, 2013, which is incorporated herein by reference in its entirety.

### TECHNICAL FIELD

The technical field relates to a method of correcting operating set points of an internal combustion engine.

### BACKGROUND

An internal combustion engine for a motor vehicle generally includes an engine block which defines at least one cylinder accommodating a reciprocating piston coupled to rotate a crankshaft. The cylinder is closed by a cylinder head that cooperates with the reciprocating piston to define a combustion chamber. A fuel and air mixture is cyclically disposed in the combustion chamber and ignited, thereby generating hot expanding exhaust gasses that cause the reciprocating movements of the piston.

The fuel is injected into each cylinder by a respective fuel injector. The fuel is provided at high pressure to each fuel injector from a fuel rail in fluid communication with a high pressure fuel pump that increase the pressure of the fuel received from a fuel source. The fuel injection system generally includes a fuel common rail and a plurality of electrically controlled fuel injectors, which are individually located in a respective cylinder of the engine and which are hydraulically connected to the fuel common rail through dedicated feeding conduits.

Several fuel delivery control strategies are used in the modern engine applications, in particular but not exclusively in Diesel applications, in order to reduce NOx and Particulate Material (PM) dispersion and combustion noise caused by the injectors drift during vehicle lifetime. Moreover these strategies are applied in order to fulfill the requirements related to faults detection of the Fuel Injection System and for detecting injector codes mismatch.

In particular, a known Fuel Set-point Adaptation strategy (FSA) used to detect an injection error operates by comparing the injected fuel quantity request and an estimated injection quantity by considering the intake air mass flow and the oxygen concentration in the exhaust gas. This conventional FSA strategy is based on a learning phase in which the injection error is detected and on a correction release phase that produces an improvement in the system setting, by means of a setpoint corrections (for example air path and rail pressure setpoints).

The FSA learning phase is activated if the system is in a steady state condition, defined in term of fuel request, engine speed and fuel error estimated. In this case, the actual injection is calculated taking into account the intake air \dot{m}_{Air}, measured by the mass air flow sensor (MAF sensor); the air-to fuel ratio λ, provided by an oxygen sensor installed in the exhaust line; and the stoichiometric air to fuel ratio λ_{ST} according to the following equation:

$$FuelEstimation = \frac{{\dot{m}}_{Air}}{λ} \times \frac{1}{{λ}_{ST}}$$

The FSA strategy identifies the fuel injection error as the difference between the injection request by the Engine Control Unit (ECU) and fuel estimation based on oxygen sensor and mass air flow sensor:

FuelInjectionError=Fuel Request−Fuel Estimation

The main deficiency of the fuel injection error estimation strategy currently used is that this strategy is intrinsically based on steady state conditions of the engine, since it cannot be activated in a transient state thereof without a decrease of the learning accuracy.

The air to fuel ratio, provided by the oxygen sensor, and the air mass flow that intakes into the combustion chamber are measured at different instants, a phenomenon that can produce wrong fuel injection estimations and consequently an incorrect detection of the injectors drift. Furthermore these sensors may exhibit delays in the measurement due to their physical characteristics.

Nevertheless, the current Fuel Set-point Adaptation (FSA) strategy is able to correct the system and reduce emissions over the lifetime of the engine in case of injectors drift that is caused by ageing effects, because the deviation occurs typically in a slow way and with a monotonic trend and it is not necessary to activate the learning in critical conditions to have a fast correction available. If limited to this case, the functionality the fuel error detection in steady state is sufficient and achieves good accuracy.

However, when the conventional FSA strategy is used to detect faults on fuel injection system, the strategy performance may be insufficient, due to the fact that the FSA strategy should be able to identify the injectors drift and compensate the system in a quick way and in a limited number of driving cycles.

### SUMMARY

The present disclosure provides a method of correcting the setpoints which extends the FSA learning procedure for transient states of the engine, in order to have a fuel correction available as soon as possible. The present disclosure also provides dynamic fuel estimation based on oxygen and intake air measurements that takes into account the signals delay in order to provide consistent measurements, and for transient states of the engine without using complex devices and by taking advantage from the computational capabilities of the Electronic Control Unit (ECU) of the vehicle. The present disclosure provides these improvements a simple, rational and inexpensive solution.

An embodiment of the present disclosure provides a method of correcting operating set points of an internal combustion engine connected to an air intake duct equipped with a mass airflow sensor, and connected to an exhaust pipe equipped with an oxygen sensor. The method includes predetermining an oxygen sensor time correction factor representative of a delay between a combustion event of a fuel quantity injected into a cylinder of the engine and a measurement in the exhaust pipe of an air-to-fuel ratio produced by said combustion event. A fuel injection error quantity is calculated as a difference between a nominal fuel quantity and an estimated fuel quantity injected into the cylinder. The nominal fuel quantity is determined for an injection that precedes the measurement of an air-to-fuel ratio value by the oxygen sensor time correction factor. The estimated fuel quantity is determined as a function of an air mass flow value and of the measured air-to-fuel ratio value. The operating set points of the internal combustion engine are corrected using the calculated fuel injection error quantity.

An advantage of this embodiment is that it provides a dynamic fuel injection estimation that identifies a drift in the fuel injection system during a steady state condition of the engine and also during transient conditions. Therefore, by virtue of this embodiment, the fuel setpoint adaptation (FSA) learning can be extended to transient states of the engine. This embodiment also makes available faster corrections reducing dependency of the learning phase of the FSA strategy on the driving style and, as a consequence, the above disclosed strategy can be applied both to compensate the injection system deviation caused by ageing effects and for recognizing an injection fault.

According to another embodiment of the present disclosure, the oxygen sensor time correction factor is a function of an exhaust mass flow transportation delay due to the distance between a combustion chamber of the cylinder and the oxygen sensor. An advantage of this embodiment is that it allows taking into account the fact that the measurement of the air-to-fuel ratio mass flow and the combustion event that determines said air-to-fuel ratio do not occur at the same time.

According to another embodiment of the present disclosure, wherein the oxygen sensor time correction factor is a function of an oxygen sensor delay depending on an exhaust gas speed. An advantage of this embodiment is that it allows taking into account the performance of different types of oxygen sensors in different gas flow speeds.

According to a further embodiment of the present disclosure, the oxygen sensor time correction factor is a function of an ageing delay of the oxygen sensor. An advantage of this embodiment is that it allows taking into account the age of the sensor, for example in terms of mileage.

According to another embodiment, an air mass flow sensor time correction factor is predetermined as a function of a delay between a measurement of an air mass flow value in the air intake duct and a fuel combustion event in the cylinder correlated to said air mass flow. An advantage of this embodiment is that it takes into account the fact that the measurement of an air mass flow and the combustion event correlated to said air mass flow do not occur at the same time.

According to still another embodiment of the present disclosure, the fuel quantity injected into the cylinder is estimated by means of the following formula:

$$FuelEstimation ( t ) = \frac{{\dot{m}}_{Air} ( t - ( {dt}_{oxygen} + {dt}_{AFM} ) )}{λ ( t )} \times \frac{1}{{λ}_{ST}}$$

wherein:
dt_{Oxygen} is the time correction factor representative of a delay between a combustion event of a fuel quantity injected into a cylinder of the engine and a measurement of an air-to-fuel ratio λ(t) produced by said combustion event;
dt_{AFM} is the air mass flow sensor time correction factor representative of a delay between a measurement of an air mass flow value \dot{m}_{Air} and a fuel combustion event in the cylinder correlated to said air mass flow;
t is the instant at which the air-to-fuel ratio measurement is done; and
λ_{ST} is the stoichiometric air-to-fuel ratio.
   An advantage of this embodiment is that it provides a model that takes into account all the time factors involved in the measurements that must be done for performing a FSA strategy, providing therefore an enhanced strategy suitable also for extending the FSA strategy to transient states of the engine.

According to another embodiment of the present disclosure, the operating set points corrected include the set points of the positions of the actuators in the air path and a rail pressure set-point. An advantage of this embodiment is that it is allowed to act on the parameters that influence the combustion process, improving the performance of the combustion.

The present disclosure also provides an apparatus for correcting operating set points of an internal combustion engine connected to an air intake duct equipped with a mass airflow sensor, and connected to an exhaust pipe equipped with an oxygen sensor. The apparatus is configured as means for memorizing an oxygen sensor time correction factor representative of a delay between a combustion event of an actual fuel quantity injected into a cylinder of the engine and a measurement in the exhaust pipe of an air-to-fuel ratio produced by said combustion event. A apparatus is also configured as means for calculating a fuel injection error quantity as a difference between a nominal fuel quantity and an estimated fuel quantity injected into the cylinder. The nominal fuel quantity is determined for an injection that precedes the measurement of an air-to-fuel ratio value by the oxygen sensor time correction factor. The estimated fuel quantity is determined as a function of an air mass flow value and of the measured air-to-fuel ratio value. The apparatus is further configured as means for correcting the operating set points of the internal combustion engine using the calculated fuel injection error quantity.

This embodiment of the present disclosure has the same advantages of the method disclosed above. In particular, the apparatus provides dynamic fuel injection estimation that allows identifying drift in the fuel injection system during a steady state condition of the engine and also during transient conditions.

According to another embodiment of the present disclosure, the apparatus is configured as means for using the oxygen sensor time correction factor, which takes into account the fact that said factor is a function of an exhaust mass flow transportation delay due to the distance between a combustion chamber of the cylinder and the oxygen sensor. An advantage of this embodiment is that it takes into account the fact that the measurement of the air-to-fuel ratio mass flow and the combustion event that determines said air-to-fuel ratio do not occur at the same time.

According to another embodiment of the present disclosure, the apparatus is configured as means for using the oxygen sensor time correction factor, which takes into account the fact that said oxygen sensor time correction factor is a function of an oxygen sensor delay depending on an exhaust gas speed. An advantage of this embodiment is that it is allowed to take into account the performance of different types of oxygen sensors in different gas flow speeds.

According to another embodiment of the present disclosure, the apparatus is configured as means for using the oxygen sensor time correction factor, which takes into account the fact that said oxygen sensor time correction factor is a function of an oxygen sensor delay depending on an exhaust gas speed. An advantage of this embodiment is that it is allowed to take into account the performance of different types of oxygen sensors in different gas flow speeds.

According to a further embodiment of the present disclosure, the apparatus is configured as means for using the oxygen sensor time correction factor, which takes into account the fact that said oxygen sensor time correction factor is a function of an ageing delay of the oxygen sensor. An advantage of this embodiment is that it is allowed to take into account the age of the sensor, for example in terms of mileage.

According to another embodiment, the apparatus is further configured as means for using an air mass flow sensor time correction factor that is predetermined as a function of a delay between a measurement of an air mass flow value in the air intake duct and a fuel combustion event in the cylinder correlated to the air mass flow. An advantage of this embodiment is that it takes into account the fact that the measurement of an air mass flow and the combustion event correlated to said air mass flow do not occur at the same time.

According to another embodiment, the apparatus is configured as means estimating the fuel quantity injected into the cylinder by means of the following formula:

$$FuelEstimation ( t ) = \frac{{\dot{m}}_{Air} ( t - ( {dt}_{oxygen} + {dt}_{AFM} ) )}{λ ( t )} \times \frac{1}{{λ}_{ST}}$$

wherein:
dt_{Oxygen} is the time correction factor representative of a delay between a combustion event of a fuel quantity injected into a cylinder of the engine and a measurement of an air-to-fuel ratio λ(t) produced by said combustion event;
dt_{AFM} is the air mass flow sensor time correction factor representative of a delay between a measurement of an air mass flow value \dot{m}h_{Air} and a fuel combustion event in the cylinder correlated to said air mass flow;
t is the instant at which the air-to-fuel ratio measurement is done; and
λ_{ST} is the stoichiometric air-to-fuel ratio.
   An advantage of this embodiment is that it provides a model that takes into account all the time factors involved in the measurements that must be done for performing a FSA strategy, providing therefore an enhanced strategy suitable also for extending the FSA strategy to transient states of the engine.

According to another embodiment of the present disclosure, the apparatus is configured as means to correct the set points of the positions of the actuators in the air path and a rail pressure set-point. An advantage of this embodiment is that it is allowed to act on the parameters that influence the combustion process, improving the performance of the combustion.

The present disclosure provides also an automotive system including an internal combustion engine managed by an engine Electronic Control Unit. The engine is equipped with a cylinder and being connected to an air intake duct, equipped with a mass airflow sensor, and to an exhaust pipe, equipped with an oxygen sensor. The Electronic Control Unit (ECU) is configured to memorize an oxygen sensor time correction factor representative of a delay between a combustion event of an actual fuel quantity injected into a cylinder of the engine and a measurement in the exhaust pipe of an air-to-fuel ratio produced by said combustion event. The ECU is also configured to calculate a fuel injection error quantity as a difference between a nominal fuel quantity and an estimated fuel quantity injected into the cylinder. The nominal fuel quantity is determined for an injection that precedes the measurement of an air-to-fuel ratio value by the oxygen sensor time correction factor. The estimated fuel quantity being determined as a function of an air mass flow value and of the measured air-to-fuel ratio value. The ECU is further configured to use the calculated fuel injection error quantity for correcting the operating set points of the internal combustion engine. This embodiment of the present disclosure has the same advantages of the method disclosed above, in particular that it provides a dynamic fuel injection estimation that allows identifying drift in the fuel injection system during a steady state condition of the engine and also during transient conditions.

According to another embodiment of the present disclosure, the ECU is configured for using the oxygen sensor time correction factor by taking into account the fact that said factor is a function of an exhaust mass flow transportation delay due to the distance between a combustion chamber of the cylinder and the oxygen sensor. An advantage of this embodiment is that it is allowed to take into account the fact that the measurement of the air-to-fuel ratio mass flow and the combustion event that determines said air-to-fuel ratio do not occur at the same time.

According to another embodiment of the present disclosure, the ECU is configured for using the oxygen sensor time correction factor by taking into account the fact that said oxygen sensor time correction factor is a function of an oxygen sensor delay depending on an exhaust gas speed. An advantage of this embodiment is that it is allowed to take into account the performance of different types of oxygen sensors in different gas flow speeds.

According to another embodiment of the present disclosure, the ECU is configured for using the oxygen sensor time correction factor by taking into account the fact that said oxygen sensor time correction factor is a function of an oxygen sensor delay depending on an exhaust gas speed. An advantage of this embodiment is that it is allowed to take into account the performance of different types of oxygen sensors in different gas flow speeds.

According to a further embodiment of the present disclosure, the ECU is configured for using the oxygen sensor time correction factor by taking into account the fact that said oxygen sensor time correction factor is a function of an ageing delay of the oxygen sensor. An advantage of this embodiment is that it is allowed to take into account the age of the sensor, for example in terms of mileage.

According to another embodiment, the ECU is configured for using an air mass flow sensor time correction factor that is predetermined as a function of a delay between a measurement of an air mass flow value in the air intake duct and a fuel combustion event in the cylinder correlated to said air mass flow. An advantage of this embodiment is that it takes into account the fact that the measurement of an air mass flow and the combustion event correlated to said air mass flow do not occur at the same time.

According to another embodiment, the ECU is configured for estimating the fuel quantity injected into the cylinder by means of the following formula:

$$FuelEstimation ( t ) = \frac{{\dot{m}}_{Air} ( t - ( {dt}_{oxygen} + {dt}_{AFM} ) )}{λ ( t )} \times \frac{1}{{λ}_{ST}}$$

wherein:
dt_{Oxygen} is the time correction factor representative of a delay between a combustion event of a fuel quantity injected into a cylinder of the engine and a measurement of an air-to-fuel ratio λ(t) produced by said combustion event;
dt_{AFM} is the air mass flow sensor time correction factor representative of a delay between a measurement of an air mass flow value \dot{m}_{Air} and a fuel combustion event in the cylinder correlated to said air mass flow;
t is the instant at which the air-to-fuel ratio measurement is done; and
A_{ST} is the stoichiometric air-to-fuel ratio.
   An advantage of this embodiment is that it provides a model that takes into account all the time factors involved in the measurements that must be done for performing a FSA strategy, providing therefore an enhanced strategy suitable also for extending the FSA strategy to transient states of the engine.

According to another embodiment of the present disclosure, the ECU is configured for correcting the set points of the positions of the actuators in the air path and a rail pressure set-point. An advantage of this embodiment is that it is allowed to act on the parameters that influence the combustion process, improving the performance of the combustion.

The method according to one of its aspects can be carried out with the help of a computer program including a program-code for carrying out all the steps of the method described above, and in the form of computer program product including the computer program. The computer program product can be embodied as a control apparatus for an internal combustion engine, including an Electronic Control Unit (ECU), a data carrier associated to the ECU, and the computer program stored in a data carrier, so that the control apparatus defines the embodiments described in the same way as the method. In this case, when the control apparatus executes the computer program all the steps of the method described above are carried out.

A still further aspect of the disclosure provides an internal combustion engine specially arranged for carrying out the method claimed.

### BRIEF DESCRIPTION OF THE DRAWINGS

The present disclosure will hereinafter be described in conjunction with the following drawing figures, wherein like numerals denote like elements.

FIG. 1 shows an automotive system;

FIG. 2 is a cross-section of an internal combustion engine belonging to the automotive system of FIG. 1;

FIG. 3 is a schematic representation of an intake duct connected to the engine of FIG. 2;

FIG. 4 is a schematic representation of an exhaust pipe connected to the engine of FIG. 2;

FIG. 5 is a graph representing fuel estimation during a transient phase of the engine according to a prior art strategy;

FIG. 6 is a graph representing fuel estimation during a transient phase of the engine obtained with a strategy according to one embodiment of the present disclosure; and

FIG. 7 is a flowchart representing an embodiment of the method of the present disclosure.

### DETAILED DESCRIPTION

Exemplary embodiments will now be described with reference to the enclosed drawings without intent to limit application and uses.

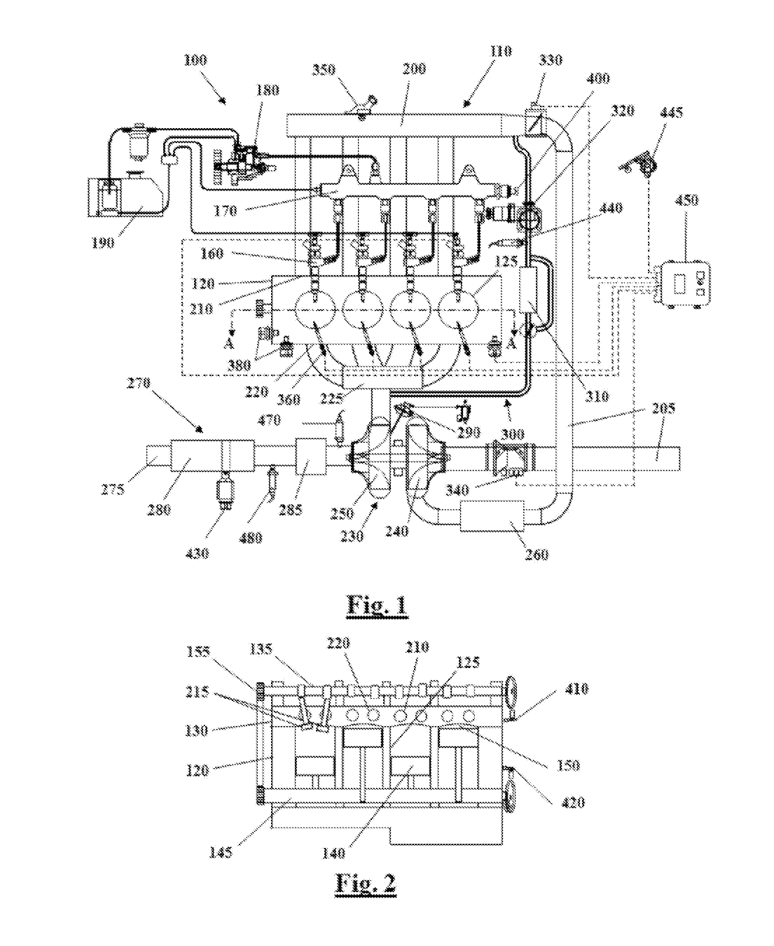

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system 25 such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270.

This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust after treatment devices 280. The after treatment devices may be any device configured to change the composition of the exhaust gases. Some examples of after treatment devices 280 include, but are not limited to, catalytic converters (two and three way), oxidation catalysts, lean NOx traps, hydrocarbon adsorbers, selective catalytic reduction (SCR) systems, and particulate filters. Other embodiments may include an exhaust gas recirculation (EGR) system 300 coupled between the exhaust manifold 225 and the intake manifold 200.

The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow sensor 340, a temperature sensor, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445.

An oxygen concentration sensor 470, also known as lambda sensor, may be placed in the exhaust line of the engine and be suitable to send information on oxygen concentration in the exhaust gas to the ECU 450. More specifically, the oxygen sensor 470 may generate a voltage based on the oxygen concentration in the exhaust gas.

Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system, or data carrier 460, and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carry out the steps of such methods and control the ICE 110.

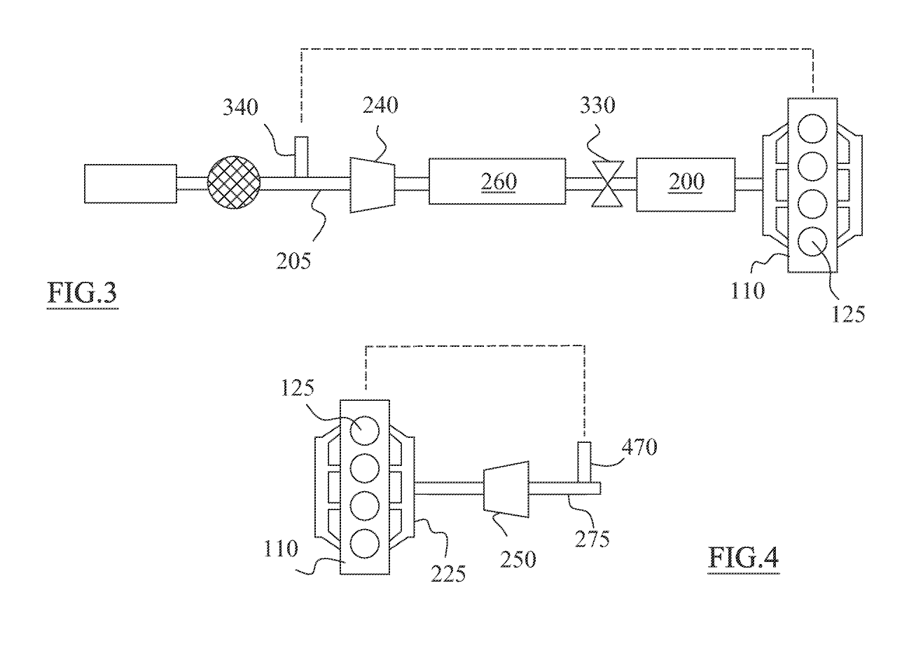

More specifically, FIG. 3 shows a schematic illustration of the air intake duct 205 connected to the engine 110. An air mass flow sensor 340 is placed in the intake duct 205 in order to measure the air mass flow that flows through the air intake duct 205 itself and therefore through the compressor 240, the intercooler 360 and the throttle 330 into the intake manifold 200 and finally into one of the cylinders 125 of the engine 110.

The air mass flow sensor 340 provides in advance an information about the intake air involved in a combustion phase that occurs in the cylinder 125 after a certain time delay, because of an air mass transportation delay between the air mass flow sensor 340 measurement and the combustion involving said mass of air in a combustion chamber of the cylinder 125. Such air mass transportation delay can be modeled by taking into account an air mass flow sensor 340 time correction factor dt_{AFM} that is representative of the above mentioned transportation delay. The value of this time correction factor dt_{AFM} can be determined for a specific engine system by virtue of an experimental activity that may involve a calibration phase. FIG. 4 is a schematic representation of the exhaust pipe 275 connected to the engine 110.

The exhaust gas that is a product of the combustion in a combustion chamber of a cylinder 125 flows through the turbine 250 and in the exhaust pipe 275 and the oxygen concentration therein is measured by the oxygen sensor 470. Furthermore, the oxygen concentration measured at a certain instant in time in the exhaust gas is representative of a combustion event that has occurred in a combustion chamber of cylinder 125 at a previous time with respect to the time of measurement by the oxygen sensor 470. Such oxygen sensor delay can be modeled by taking into account an oxygen sensor 470 time correction factor dt_{Oxygen}. This time correction factor dt_{Oxygen} is representative of a delay between the combustion of a fuel quantity injected into the cylinder 125 and the measurement in the exhaust pipe 275 of an air-to-fuel ratio λ produced by said combustion.

The oxygen sensor 470 time correction factor dt_{Oxygen} can be determined by taking into account that this delay is due to different factors. First, the oxygen sensor 470 time correction factor dt_{Oxygen} incorporates an exhaust gas transportation delay in the exhaust line 275, due to the distance between the combustion chamber and the oxygen sensor 470, considering also that the exhaust gas must pass through the exhaust manifold 225.

Furthermore, the time correction factor dt_{Oxygen} incorporates an oxygen sensor 470 delay that is related to the sensor performance of the specific type of oxygen sensor employed and to the exhaust gas speed and an ageing delay that takes in consideration ageing effects on oxygen sensor 470 performances. The ageing delay may be expressed as a function of the mileage, and in this case, can be calculated by a corresponding function by the ECU 450. Therefore the value of the time correction factor dt_{Oxygen} can be determined for a specific engine system by virtue of an experimental activity that may involve a calibration phase and also the knowledge of the specific type of oxygen sensor 470 used and of its performance as a function of its ageing.

The air mass flow sensor time correction factor dt_{AFM} and the oxygen sensor 470 time correction factor dt_{Oxygen}, once predetermined by the procedures above, can be memorized in a data carrier 460 of the ECU 450 for further use in the various embodiments of the present disclosure.

According to an embodiment of the present disclosure, since the engine 110 can be operated either in a steady-state condition or in a transient condition, it is useful to take a time reference value t, namely the instant at which the oxygen measurement is done. With this convention, a fuel quantity injected FuelEstimation (t) can be estimated considering also the delays due to the sensors above mentioned, according to the following Equation (1):

$$FuelEstimation ( t ) = \frac{{\dot{m}}_{Air} ( t - ( {dt}_{oxygen} + {dt}_{AFM} ) )}{λ ( t )} \times \frac{1}{{λ}_{ST}} \qquad ( 1 )$$

wherein:
dt_{Oxygen} is the time correction factor representative of a delay between a combustion event of a fuel quantity injected into a cylinder of the engine and a measurement of an air-to-fuel ratio λ(t) produced by said combustion event;
dt_{AFM} is the air mass flow sensor time correction factor representative of a delay between a measurement of an air mass flow value \dot{m}_{Air} and a fuel combustion event in the cylinder correlated to said air mass flow;
t is the instant at which the air-to-fuel ratio measurement is done; and
λ_{ST} is the stoichiometric air-to-fuel ratio.
   Therefore, according to Equation (1), the air mass flow to be considered, in order to apply an enhanced FSA strategy according to the various embodiment of the present disclosure, is the one measured at an instant that precedes the instant t of the oxygen measurement by a time equal to (t−(dt_{Oxygen}+dt_{AFM}). This value is used in Equation (1) in order to be divided by the value of the air-to-fuel ratio measured at time t, namely λ(t), to find an estimated fuel value FuelEstimation (t). Furthermore, the ratio 1/λ_{ST} is used to normalize the measured air-to-fuel ratio λ(t), with respect to the stoichiometric air-to-fuel ratio.

The determination of an injected fuel quantity error FuelInjectionError for a specific injection can be performed by the difference between a nominal fuel quantity request FuelRequest generated by the ECU and the estimated fuel quantity FuelEstimation for the same injection. The nominal fuel quantity request FuelRequest for a specific injection into cylinder 125 is calculated by the ECU 450 as a function of a request, for example expressed by an accelerator pedal position measured by accelerator pedal position sensor 445. The fuel quantity injected for the same injection FuelEstimation can be estimated by Equation (1).

With these data, the fuel injection error FuelInjectionError (t) at time t is calculated by using the following Equation (2):

FuelInjectionError(t)=FuelRequest(t−dt_{Oxygen})−FuelEstimation(t) (2)

wherein: the estimated fuel quantity FuelEstimation(t) is calculated by means of Equation (1).

Also in this case, it is necessary to consider the delay between the air-to-fuel ratio measurement in the exhaust pipe 275 and the combustion in the cylinder 125 that produces said air-to-fuel ratio, such delay being expressed by the oxygen sensor time correction factor dt_{Oxygen}. The use of the oxygen sensor time correction factor dt_{Oxygen}, allows to consider the correct FuelRequest value to be compared with the FuelEstimation value provided by Equation (1), since the FuelEstimation value at time t is the consequence of an injection that precedes the instant t by the time correction factor dt_{Oxygen}.

Table 1 represents a numerical example of this strategy, where it is intended that the specific numerical values are disclosed only for illustrative purposes and are not representative of any particular engine system.

TABLE 1

| | Time | | | | | | |
|---|---|---|---|---|---|---|---|
| | t1 | t2 | t3 | t4 | t5 | t6 | t7 |
| Fuel Request | 10 | 11 | 12 | 13 | 14 | 12 | 12 |
| Fuel Estimation | 5 | 5 | 7 | 8 | 9 | 10 | 11 |

In this case, a transient state of the engine 110 has been represented giving rise to different values of the FuelRequest variable at different instants of time. Under the hypothesis that the measurement delay of the oxygen sensor is equal to three instants of time, namely dt_{Oxygen}=3, the consequences of the combustion event at time t1 are measured at time t4. Therefore, applying Equation (2):

FuelInjectionError(t4)=FuelRequest(t4−dt_{Oxygen})−FuelEstimation(t4)

which gives:

FuelInjectionError(t4)=FuelRequest(t1)−FuelEstimation(t4)

And, in numerical terms from TABLE 1:

FuelInjectionError(t4)=10−8=2.

The calculated fuel injection error quantity FuelInjectionError can then be used for correcting the operating set points of the internal combustion engine 110.

FIG. 5 is a graph representing a fuel estimation procedure during a transient phase of the engine according to a prior art strategy. In this case curve A represents the fuel request determined by the ECU 450 on the basis of a torque request from the driver of the vehicle, while curve B represents the quantity of fuel injected into the engine 110 as estimated by a FSA strategy of the prior art. It can be seen that the prior art strategy does not take into account the delay of measurement that is intrinsically present in a transient phase of the engine 110.

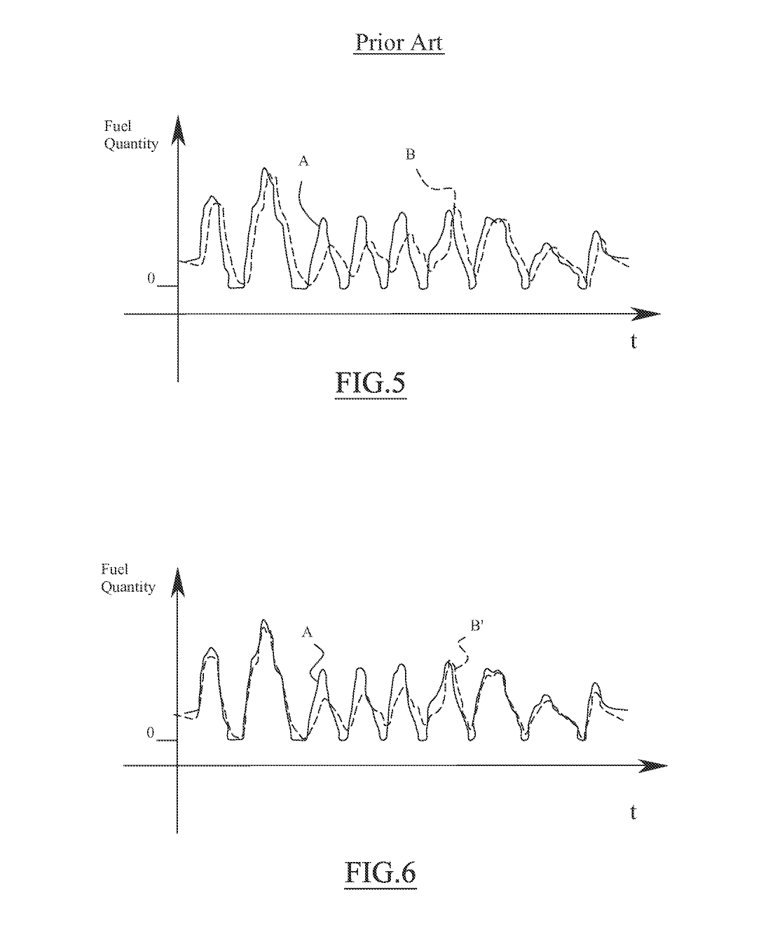

FIG. 6 is a graph representing fuel estimation during a transient phase of the engine obtained with a strategy according to one embodiment of the present disclosure. Also in this case curve A represents the fuel request determined by the ECU 450 on the basis of a torque request from the driver of the vehicle, while curve B′ represents the quantity of fuel injected into the engine 110 as estimated by a strategy according to one embodiment of the present disclosure. It can be seen that, in this case, curve B′ does not show a significant time lag with respect to curve A, namely with respect to the fuel quantity estimation, and even in a transient phase of the engine 110, mirrors closely the fuel request.

As stated above, the calculated fuel injection error quantity FuelInjectionError can then be used for correcting the operating set points of the internal combustion engine 110. The operating set points corrected include the set points of the positions of the actuators in the air path and a fuel rail 170 pressure set-point. Examples of actuators in the air path may be the EGR valve 320 and the throttle body 330.

The fuel injection estimation according to the various embodiments of the present disclosure is allowed to identify drift in the fuel injection system during the steady-state and during several transient conditions. The FSA learning has therefore been extended in transient state, getting a faster correction available and reducing the dependency on the driving style and as consequence the strategy can be applied both to compensate the injection system deviation caused by ageing effects, or in case the strategy recognizes an injection fault.

The detection of the injection error according to the various embodiments of the present disclosure allows to improve the performance of the engine system by means of the various set-points corrections, for example reducing NOx−PM dispersion and combustion noise, caused by the injectors drift during vehicle lifetime and in general the engine system is maintained at in optimal conditions for the fuel combustion.

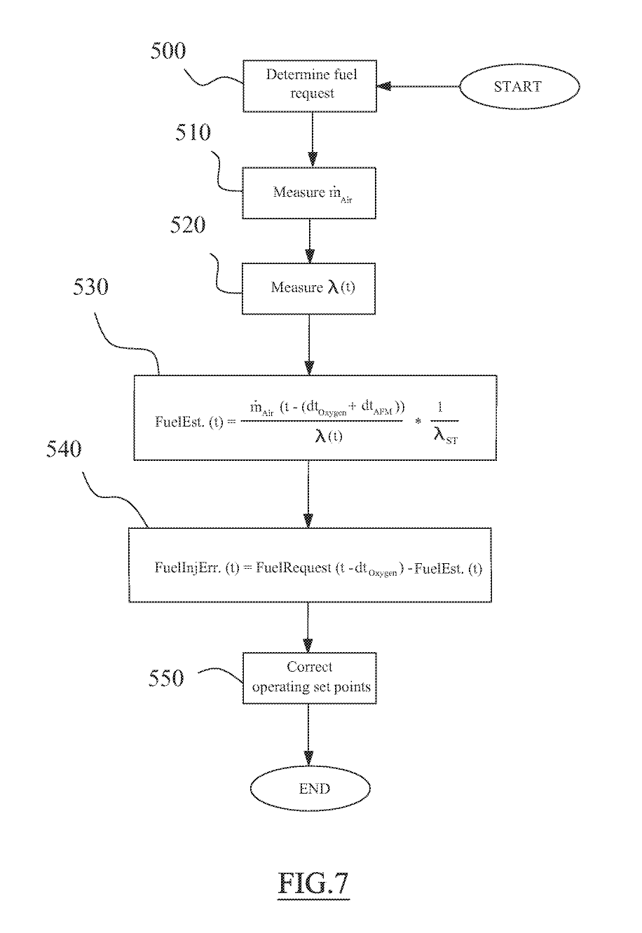

Finally, FIG. 7 is a flowchart representing an embodiment of the method of the present disclosure. As a first step, the Electronic Control Unit 450 determines a fuel request (block 500) based, for example, on a user's request measured by the position of an accelerator pedal. The air mass flow value \dot{m}_{Air} in the air intake duct 205 is measured, for example by means of sensor 340 mass airflow sensor 340 (block 510) and the air-to-fuel ratio in the exhaust pipe 275 is measured by means of oxygen sensor 470 (block 520).

Then, on the basis of these two values, the actual fuel quantity injected into a cylinder 125 is estimated (block 530) by means of Equation (1) above, namely:

$$FuelEstimation ( t ) = \frac{{\dot{m}}_{Air} ( t - ( {dt}_{oxygen} + {dt}_{AFM} ) )}{λ ( t )} \times \frac{1}{{λ}_{ST}} \qquad ( 1 )$$

A fuel injection error is then calculated (block 540) by means of Equation (2) above, namely:

FuelInjectionError(t)=FuelRequest(t−dt_{Oxygen})−FuelEstimation(t) (2)

Then the calculated fuel injection error quantity (FuelInjectionError) is used for correcting the operating set points of the internal combustion engine (110).

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

1. (canceled)

14. A method of correcting operating set points of an internal combustion engine connected to an air intake duct having a mass airflow sensor, and connected to an exhaust pipe having an oxygen sensor, the method comprising:
predetermining an oxygen sensor time correction factor (dt_{Oxygen}) representative of a delay between a combustion event of a fuel quantity injected into a cylinder of the engine and a measurement in the exhaust pipe of an air-to-fuel ratio (λ) produced by said combustion event;
calculating a fuel injection error quantity (FuelInjectionError) as a difference between a nominal fuel quantity (FuelRequest) and an estimated fuel quantity (FuelEstimation) injected into the cylinder; and
correcting the operating set points of the internal combustion engine using the calculated fuel injection error quantity (FuelInjectionError);
wherein the nominal fuel quantity (FuelRequest) is determined for an injection that precedes the measurement of an air-to-fuel ratio value (λ(t) by the oxygen sensor time correction factor (dt_{Oxygen}); and
wherein the estimated fuel quantity (FuelEstimation) is determined as a function of an air mass flow value (\dot{m}_{Air}) and of the measured air-to-fuel ratio value (λ).

15. A method according to claim 14, wherein the oxygen sensor time correction factor (dt_{Oxygen}) is a function of an exhaust mass flow transportation delay due to the distance between a combustion chamber of the cylinder and the oxygen sensor.

16. A method according to claim 15, wherein the oxygen sensor time correction factor (dt_{Oxygen}) is a function of an oxygen sensor delay depending on an exhaust gas speed.

17. A method according to claim 15, wherein the oxygen sensor time correction factor (dt_{Oxygen}) is a function of an ageing delay of the oxygen sensor.

18. A method according to claim 14, wherein an air mass flow sensor time correction factor (dt_{Oxygen}) is predetermined as a function of a delay between a measurement of an air mass flow value (\dot{m}_{Air}) in the air intake duct and a fuel combustion event in the cylinder correlated to said air mass flow.

19. A method according to claims 14, wherein the fuel quantity injected (FuelEstimation(t)) into the cylinder is estimated as follows:
$$FuelEstimation ( t ) = \frac{{\dot{m}}_{Air} ( t - ( {dt}_{oxygen} + {dt}_{AFM} ) )}{λ ( t )} \times \frac{1}{{λ}_{ST}}$$
wherein:
dt_{Oxygen} is the time correction factor representative of a delay between a combustion event of a fuel quantity injected into a cylinder of the engine and a measurement of an air-to-fuel ratio λ(t) produced by said combustion event;
dt_{AFM} is the air mass flow sensor time correction factor representative of a delay between a measurement of an air mass flow value \dot{m}_{Air}(t) and a fuel combustion event in the cylinder correlated to said air mass flow,
t is the instant at which the air-to-fuel ratio measurement is done, and λ_{ST} is the stoichiometric air-to-fuel ratio.

20. A method according to claim 14, wherein the corrected operating set points comprise the set points of the positions of the actuators in the air path and a fuel rail pressure set-point.

21. An internal combustion engine equipped with a fuel injector for injecting fuel into a cylinder of the engine connected to an air intake duct and to an exhaust pipe, the internal combustion engine operably controlled by an Electronic Control Unit configured to carry out the method according to claim 14.

22. A non-transitory computer-readable medium comprising a computer program product configured to make a computer execute the method according to claim 14.

23. An apparatus for correcting operating set points of an internal combustion engine, the engine being connected to an air intake duct having a mass airflow sensor, and connected to an exhaust pipe having an oxygen sensor, the apparatus comprising:
means for memorizing an oxygen sensor time correction factor (dt_{Oxygen}) representative of a delay between a combustion event of an actual fuel quantity injected into a cylinder of the engine and a measurement in the exhaust pipe of an air-to-fuel ratio (λ) produced by said combustion event;
means for calculating a fuel injection error quantity (FuelInjectionError) as a difference between a nominal fuel quantity (FuelRequest) and an estimated fuel quantity (FuelEstimation) injected into the cylinder, wherein the nominal fuel quantity (FuelRequest) is determined for an injection that precedes the measurement of an air-to-fuel ratio value (λ(t)) by the oxygen sensor time correction factor (dt_{Oxygen}), and wherein the estimated fuel quantity (FuelEstimation)is determined as a function of an air mass flow value (\dot{m}_{Air}) and of the measured air-to-fuel ratio value (λ); and
means for correcting the operating set points of the internal combustion engine using the calculated fuel injection error quantity (FuelInjectionError).

24. An automotive system comprising an internal combustion engine managed by an Electronic Control Unit, the engine being equipped with a cylinder and being connected to an air intake duct having a mass airflow sensor, and connected to an exhaust pipe having an oxygen sensor, the Electronic Control Unit configured to:
memorize an oxygen sensor time correction factor (dt_{Oxygen}) representative of a delay between a combustion event of an actual fuel quantity injected into a cylinder of the engine and a measurement in the exhaust pipe of an air-to-fuel ratio (λ) produced by said combustion event;
calculate a fuel injection error quantity (FuelInjectionError) as a difference between a nominal fuel quantity (FuelRequest) and an estimated fuel quantity (FuelEstimation) injected into the cylinder, wherein the nominal fuel quantity (FuelRequest)is determined for an injection that precedes the measurement of an air-to-fuel ratio value λ(t) by the oxygen sensor time correction factor (dt_{Oxygen}), and wherein the estimated fuel quantity (FuelEstimation)is determined as a function of an air mass flow value \dot{m}_{Air} and of the measured air-to-fuel ratio value λ; and
use the calculated fuel injection error quantity (FuelInjectionError) for correcting the operating set points of the internal combustion engine.
